(19) United States
(12) Patent Application Publication
(10) Pub. No.: US 2002/0000451 A1
(43) Pub. Date: Jan. 3, 2002

(54) Drum bung adapter

(76) Inventor: Mark G. Hansen, Ignace (CA)

Correspondence Address: AIKINS, MACAULAY & THORVALDSON, 30TH FLOOR COMMODITY EXCHANGE TOWER, 360 MAIN STREET, WINNIPEG, MB, R3C 4G1, CA

(21) Appl. No.: 09/883,312

(22) Filed: Jun. 19, 2001

(30) Foreign Application Priority Data
Jun. 29, 2000 (CA) 2,312,677

(51) Int. Cl. B67D 5/58

(52) U.S. Cl. 222/189.1; 222/464.2; 222/481

(57) ABSTRACT

An adapter is used for the removal of liquid contents from storage drums. The adapter has a bung body that threads into the normal bung hole of the storage drum and is sealed to the drum head. A hose fitting on the bottom of the bung body is connected to a suction hose that extends to the bottom of the drum. On the top of the bung body is a quick release, valved fitting. The bung body also has a vent to admit air into the drum as liquid is withdrawn from it. The vent is equipped with a spring-loaded check valve so as to be normally closed.

### FIELD OF THE INVENTION

The present invention relates to an adapter for use with storage drums that allows the direct withdrawal of a drum's liquid contents so that the drum can be used directly as a supply of those contents.

### BACKGROUND

Where liquid, for example fuel, is transported in drums for use at remote locations it is common to transfer the liquid from the drum to a separate tank for use. The transfer is often done by tipping the drum and pouring its contents. The tank is equipped with the requisite connections to the equipment to which the liquid is to be supplied. It may, for example, be a fuel tank for a motor.

The transfer process is often laborious and time consuming. It may result in unacceptable spills, particularly where noxious substances are involved.

The present invention provides a simple, effective mechanism to allow the pumping of liquids from storage drums.

### SUMMARY

According to the present invention there is provided an adapter for a storage drum of the type having a threaded bung hole, said adapter comprising:

a bung with top and bottom sides and including:

a main body at the top side of the bung;

a threaded plug at the bottom side of the bung and projecting from the main body, the plug being sized and configured to screw into the threaded bung hole of the storage drum;

a liquid passage through the bung from the top side to the bottom side;

a vent bore through the bung from the top side to the bottom side;

a check valve in the vent bore allowing and preventing air from passing through the vent bore from the bottom side of the bung to the top side;

a hose fitting secured to the top side of the bung in communication with the fluid passage therethrough for connection to a hose; and

a suction hose secured to the bottom side of the bung in communication with the fluid passage.

This adapter screws into the bung hole of a storage drum. With the suction hose extending to the bottom of the drum, all of the liquid from the drum may be withdrawn, often directly to the equipment using the liquid. This eliminates entirely the transfer of liquid from the drum to a tank. Because of the vent opening and the check valve in that passage, no secondary opening in the drum need be provided to allow air access as liquid is withdrawn from the drum. The check valve prevents liquids and vapours from leaving the drum. For the same purpose, it is preferred that the hose fitting is a quick release fitting with an internal valve that opens when the fitting is connected. This means that the drums is sealed by the check valve and the internal valve coupling when it is not in use.

### BRIEF DESCRIPTION OF THE DRAWINGS

In the accompanying drawings, which illustrate an exemplary embodiment of the present invention:

FIG. 1 is an isometric illustration of a drum with an adapter according to the present invention;

FIG. 2 is a partial isometric view of an adapter according to the present invention; and

FIG. 3 is a longitudinal cross-section through the adapter.

### DETAILED DESCRIPTION

Referring to the accompanying drawings, FIG. 1 illustrates a storage drum 10 of the conventional type for transporting and storing large volumes of liquids. The drum has at one end a bung hole 12 with an internal thread 14. This is normally sealed closed with a threaded plug or bung 16. The illustrated drum is also equipped with a smaller sized threaded vent hole 18, which is closed with a threaded plug 20. An adapter 22 according to the present invention is used with this drum to withdraw liquid from the drum.

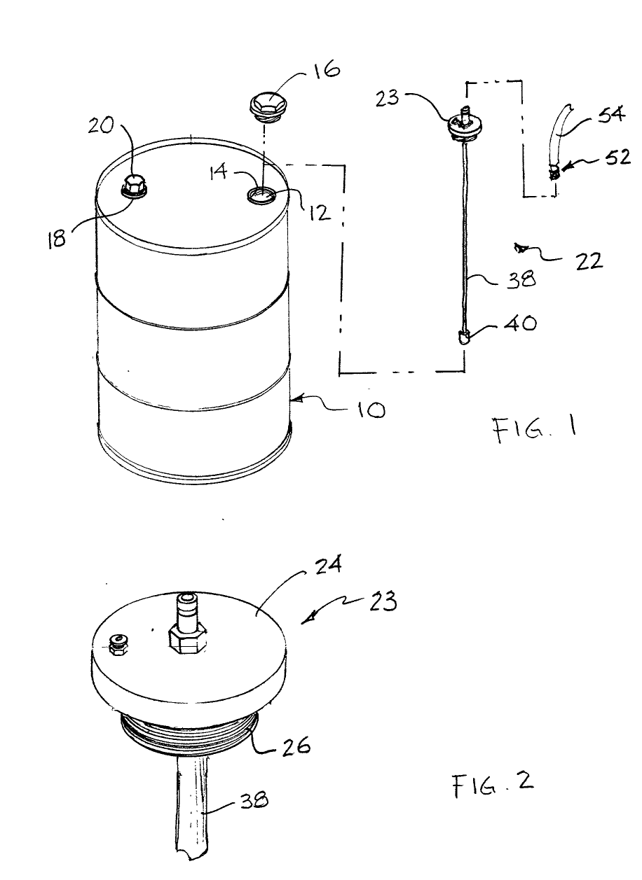

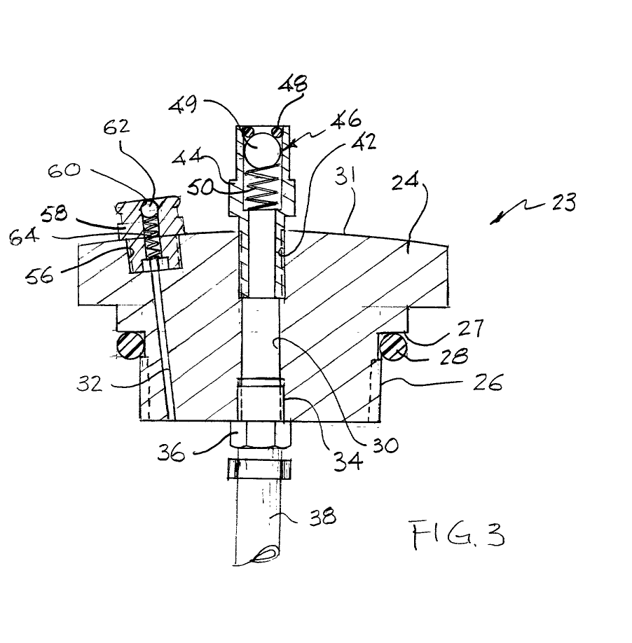

The adapter includes a bung 23, the structure of which is illustrated most particularly in FIGS. 2 and 3. The adapter bung 23 has a main body 24 carrying a threaded plug 26 projecting from its bottom surface 27. An o-ring seal 28 surrounds the threaded plug at the bottom of the main body to seal the bung to the bung hole 12 when the threaded plug 26 is screwed into the bung hole 12.

As illustrated most particularly in FIG. 3, there is a through bore 30 extending from the bottom side of the plug 26 through the top side 31 of the main body 24. A second vent bore 32 also extends from the bottom of the plug to the top of the main body. At the bottom of the plug 26, the bore 30 has a thread 34 into which is screwed a suction hose fitting 36 connected to a suction hose 38. The suction hose serves as a dip tube extending to the bottom of the drum when the adapter is in place. At its end remote from the bung it carries a filter 40. At the top end of the bore 30 is a counterbore 42 into which is threaded one component 44 of a quick release coupling 45. Coupling component 44 includes an internal valve 46. The valve has a seat 48, a valve head 49 and a spring 50 pressing the valve head into engagement with the seat so that the valve is normally closed. The second component 52 of the quick release coupling is connected to a hose 54 leading to the device to which the liquid in the drum is to be supplied.

The vent bore 32 has a counter bore 56 at the top into which a check valve 58 is threaded. The check valve includes a seat 60 against which a ball 62 is engaged under the bias of a spring 64.

In use, the drum bung is removed from the drum and the adapter is threaded into the bung hole 12. The suction hose 38 extends from the adapter down to the bottom of the drum. At this point, the drum remains completely sealed. To use the drum, the second component 52 of the quick release coupling is engaged with the component 44 on the adapter. The second component includes a stud (not shown) that depresses the valve head 49 to allow flow of liquid around the valve head and through the valve. When closed and no longer required, the coupling can be released, leaving the drum sealed but ready for re-use at any time.

While one embodiment of the present invention has been described in the foregoing, it is to be understood that other embodiments are possible within the scope of the invention and are intended to be included herein. The invention is to be considered limited solely by the scope of the appended claims.

1. An adapter for a storage drum of the type having a threaded bung hole, said adapter comprising:
a bung with top and bottom sides and including:
a main body at the top side of the bung;
a threaded plug at the bottom side of the bung and projecting from the main body, the plug being sized and configured to screw into the threaded bung hole of the storage drum;
a liquid passage through the bung from the top side to the bottom side;
a vent bore through the bung from the top side to the bottom side;
a check valve in the ventilation bore allowing air to pass through the ventilation bore from the top side of the bung to the bottom side;
a hose fitting secured to the top side of the bung in communication with the fluid passage therethrough for connection to a hose; and
a suction hose secured to the bottom side of the bung in communication with the fluid passage.

2. An adapter according to claim 1 wherein the hose fitting is one part of a quick release coupling for connection to a second part of the quick release coupling fitted on the end of a hose.

3. An adapter according to claim 2 wherein the hose fitting includes a valve.

4. An adapter according to claim 3 wherein the valve is normally closed and opens in response to connection of the second part of the fitting with the first part.

5. An adapter according to claim 1 wherein the suction hose includes a filter at an end thereof remote from the bung.
